(19) United States
(12) Patent Application Publication
(10) Pub. No.: US 2024/0017689 A1
(43) Pub. Date: Jan. 18, 2024

(54) FULLY INTEGRATED COMPACT POWER MODULE

(71) Applicant: Hyliion Inc., Cedar Park, TX (US)

(72) Inventors: Patrick Sexton, Austin, TX (US); Jay Kevin Neutzler, Austin, TX (US); Jason Sinnema, Austin, TX (US); Michael Schofield, Georgetown, TX (US)

(21) Appl. No.: 18/352,492

(22) Filed: Jul. 14, 2023

Related U.S. Application Data
(60) Provisional application No. 63/368,432, filed on Jul. 14, 2022.

(51) Int. Cl. B60R 16/033; H02J 7/14

(52) U.S. Cl. CPC B60R 16/033; H02J 7/14; B60L 50/61

(57) ABSTRACT

Systems and methods of providing one or more fully integrated compact power modules in a vehicle are disclosed. The fully integrated compact power module is mounted to a vehicle and includes: a housing, a battery system disposed in the housing, and a generator disposed in the housing. The battery system selectively supplies electrical power to the generator, at least one component or system of the vehicle, at least one component or system independent of the vehicle, or a combination thereof. The generator selectively burns one or more fuels to generate electrical power and selectively supplies the generated electrical power to the battery system, at least one component or system of the vehicle, at least one component or system independent of the vehicle, or a combination thereof. The generator also selectively supplies heating or cooling to at least one building, enclosure, or other structure.

### CROSS-REFERENCE TO RELATED APPLICATIONS

This application claims the benefit of U.S. Provisional Patent Application No. 63/368,432, filed on Jul. 14, 2022, which is incorporated by reference herein in its entirety.

### FIELD

The present disclosure relates generally to power modules and more particularly to fully integrated compact power modules.

### BACKGROUND

Electric and hybrid-electric powertrain systems for vehicles typically include a battery system to provide motive electrical force to a powertrain of a vehicle, power generation hardware to generate electrical power to charge the battery system, and a system controller to control operation of the powertrain system. Traditional electric and hybrid-electric powertrain systems are often installed with the battery system displaced or separated from the power generation hardware. This displacement or separation complicates installation by requiring additional components, interfaces, or wiring between components or subsystems and further complicates maintenance and/or and testing by restricting access to and/or requiring removal of the individual components or subsystems of the powertrain system.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 shows a schematic side view of a fully integrated compact power module according to an embodiment of the disclosure.

FIG. 2 shows a schematic side view of a vehicle having one or more fully integrated compact power modules according to an embodiment of the disclosure.

FIGS. 3A to 3G show schematic side views of vehicles having a plurality of fully integrated compact power modules according to embodiments of the disclosure.

FIG. 4 shows a schematic side view of a vehicle having a plurality of fully integrated compact power module according to an embodiment of the disclosure.

FIG. 5 shows a schematic side view of a vehicle having a plurality of fully integrated compact power modules according to an embodiment of the disclosure.

FIG. 6 shows a flowchart of a method of operating a vehicle according to an embodiment of the disclosure.

The use of the same reference symbols in different drawings indicates similar or identical items.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

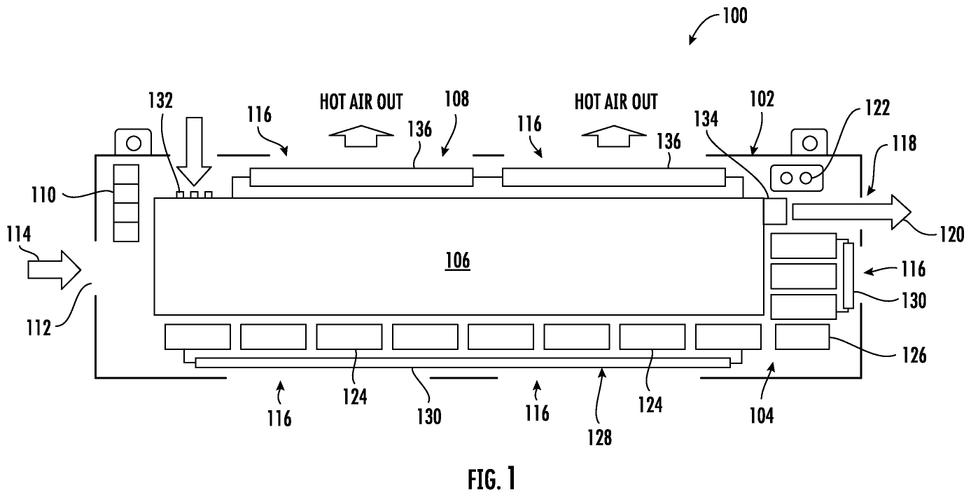

Referring now to the drawings, FIG. 1 shows a schematic side view of a fully integrated compact power module 100 according to an embodiment of the disclosure. The fully integrated compact power module (hereinafter “power module”) 100 may generally include a housing 102, a battery system 104 disposed in the housing, and a generator 106 disposed in the housing. In some embodiments, the power module 100 may include a cooling system 108 coupled to the generator 106. Further, in some embodiments, the power module 100 may also include a system controller 110 configured to control operation of the power module 100.

The housing 102 may generally be configured for mounting to a vehicle, a structure, or a combination thereof. The housing 102 includes one or more inlets 112 that may allow airflow 114 into the housing 102 and to the generator 106. In some embodiments, the one or more inlets 112 may be oriented towards a primary direction of travel of a vehicle to which the power module 100 is mounted. Accordingly, the one or more inlets 112 may operate as forced air induction inlets during travel of the vehicle. The housing 102 includes one or more outlets 116 that may allow the airflow 114 to escape from the housing 102. In some embodiments, the one or more outlets 116 may be disposed on a different side of the housing 102 from the one or more inlets 112. The housing 102 may also include one or more exhaust outlets 118 through which exhaust or emissions 120 from the generator 106 may escape from the housing 102. In some embodiments, the housing 102 may include one or more electrical ports 122 through which the battery system 104 may supply electrical power, the generator 106 may supply generated electrical power, or a combination thereof.

The battery system 104 may generally be disposed in the housing 102 and configured to selectively supply electrical power to at least one component or system. The battery system 104 may include one or more batteries or battery packs 124. In some embodiments, each battery or battery pack 124 may include a plurality of battery cells. The battery packs 124 may be configured to store electrical power and deliver the electrical power upon demand. It will be appreciated that the battery packs 124 may be electrically coupled in parallel, series, or a combination thereof depending on the application, configuration, and/or voltage requirements of the components or systems to which the battery system 104 may provide electrical power. In some embodiments, the battery packs 124 may be disposed on one or more sides of the generator 106. In some embodiments, the battery packs 124 may be disposed on a single side of the generator 106. However, in other embodiments, the battery packs 124 may be disposed on a plurality of sides of the generator 106. For example, the battery packs 124 may be disposed on a top, a bottom, a front, a back, a left side, and/or a right side of the generator 106.

The battery system 104 may also include a battery management controller 126. The battery management controller 126 may be configured to selectively control an amount of the electrical power supplied from the one or more battery packs 124. The battery management controller 126 may also be disposed in the housing 102.

In some embodiments, the battery system 104 may also include a battery cooling system 128 to regulate a temperature of the one or more battery packs 124. The battery cooling system 128 may include one or more battery cooling heat exchangers 130. The one or more battery cooling heat exchangers 130 may be configured to expel heat from the battery system 104 and/or battery packs 124 by promoting heat exchange with the ambient environment and/or an airflow passing through one or more of the battery cooling heat exchangers 130. In some embodiments, one or more battery cooling heat exchangers 130 may be disposed within the housing 102 and proximate to one or more outlets 116 in the housing 102. In some embodiments, one or more battery cooling heat exchangers 130 may be disposed externally to the housing 102.

The battery system 104 may generally be configured to supply the electrical power to at least one component or system of a vehicle, at least one component or system independent of the vehicle through the one or more electrical ports 122, or a combination thereof. In some embodiments, the at least one component of the vehicle may be a drivetrain component of the vehicle. In some embodiments, the drivetrain component of the vehicle may be the generator 106, one or more motor/generators (M/G's) coupled to one or more drive axles of the vehicle and configured to provide a motive force through the one or more drive axles to propel the vehicle, or a combination thereof. In some embodiments, the at least one component of the vehicle may be a non-drivetrain component of the vehicle. In some embodiments, the non-drivetrain component of the vehicle may be an auxiliary power unit (APU) of the vehicle, a heating, ventilation, and cooling (HVC) system of the vehicle, or a combination thereof. In some embodiments, the at least one component or system independent of the vehicle may be an external electronic device, another electric or hybrid-electric vehicle, a building or other structure, an electrical grid, or a combination thereof.

The generator 106 may generally be disposed in the housing 102, coupled to the battery system 104, and configured to selectively burn one or more fuels to generate electrical power to charge the battery system 104. In some embodiments, the generator 106 may include a fuel agnostic generator and be configured to burn compressed natural gas, diesel, hydrogen, liquified petroleum gas, or any combination thereof to generate electrical power to charge the battery system 104. In some embodiments, the generator 106 may include one or more fuel inlets 132 through which the one or more fuels may enter the generator 106 for combustion. In some embodiments, the generator 106 may include a zero emissions generator. In some embodiments, the emissions 120 from the generator 106 may include only carbon dioxide, nitrogen, water, or a combination thereof. The generator 106 may expel the emissions 120 through an exhaust system 134. In some embodiments, the exhaust system 134 may include one or more exhaust pipes that extend through the one or more exhaust outlets 118 of the housing 102. However, in alternative embodiments, the generator 106 may include a hydrogen fuel cell.

The generator 106 may generally be configured to selectively burn one or more fuels to generate electrical power and supply the generated electrical power to at least one component or system of a vehicle, at least one component or system independent of the vehicle through the one or more electrical ports 122, or a combination thereof. In some embodiments, the at least one component of the vehicle may be a drivetrain component of the vehicle. In some embodiments, the drivetrain component of the vehicle may be the battery system 104, one or more motor/generators (M/G's) coupled to one or more drive axles of the vehicle and configured to provide a motive force through the one or more drive axles to propel the vehicle, or a combination thereof. In some embodiments, the at least one component of the vehicle may be a non-drivetrain component of the vehicle. In some embodiments, the non-drivetrain component of the vehicle may be an auxiliary power unit (APU) of the vehicle, a heating, ventilation, and cooling (HVC) system of the vehicle, or a combination thereof. In some embodiments, the at least one component or system independent of the vehicle may be an external electronic device, another electric or hybrid-electric vehicle, a building or other structure, the electrical grid, or a combination thereof.

The generator 106 may also be configured to selectively supply heating or cooling to at least one building, enclosure, or other structure. In some embodiments, the generator 106 may be configured to supply the generated electrical power to at least one component or system of a vehicle, at least one component or system independent of the vehicle, or a combination thereof and simultaneously supply heating to the at least one building, enclosure, or other structure. Furthermore, in some embodiments, it will be appreciated that the power module 100 may include a plurality of generators 106 disposed in the housing 102, coupled to the battery system 104, and configured to burn one or more fuels to generate electrical power to charge the battery system 104.

The power module 100 may also include a cooling system 108 configured to regulate an operating temperature of the generator 106. The cooling system 108 may include one or more heat exchangers 136 configured to expel heat generated by the combustion of the one or more fuels by the generator by promoting heat exchange with the ambient environment and/or an airflow passing through the heat exchangers 136. In some embodiments, one or more heat exchangers 136 may be disposed within the housing 102 and proximate to one or more outlets 116 in the housing 102. In some embodiments, one or more heat exchangers 136 may be disposed externally to the housing 102.

The power module 100 may also include a system controller 110 that executes instructions to control operation of the power module 100. In some embodiments, the system controller 110 may execute instructions to selectively control power delivery of the electrical power from the battery system 104 and the generated electrical power from the generator 106 to the at least one component or system of the vehicle, the at least one component or system independent of the vehicle, or a combination thereof. In some embodiments, the system controller 110 may execute instructions to selectively control power delivery based on: a destination; a location; a route; a grade of road; terrain; proximity of a fueling station to the destination, the location, and/or the route; a state of charge (SoC) of the battery system 104, or any combination thereof.

In some embodiments, the system controller 110 may also execute instructions to selectively control delivery of the heating or cooling to the at least one building, enclosure, or other structure. Still further, in some embodiments, the system controller 110 may execute instructions to selectively control which of the one or more fuels are burned by the generator 106. In some embodiments, the system controller 110 may execute instructions to control operation of a drivetrain of a vehicle to which the power module 100 is mounted. In some embodiments, the system controller 110 may further execute instructions to control operation of the entire vehicle to which the power module 100 is mounted. In some embodiments, the system controller 110 may be disposed in the housing 102. However, in some embodiments, the system controller 110 may be disposed externally to the housing 102.

The power module 100 may generally be capable of autonomous operation. The power module 100 may be configured for mounting to and operation in a vehicle, a building, enclosure, or other structure, or a combination thereof. The power module 100 may also be operable in a vertical, horizontal, or angled position. By combining the battery system 104, the generator 106, and optionally the system controller 110 in the housing 102, a fully integrated compact power module 100 is achieved. The compact design of the power module 100 may simplify installation, maintenance, and/or troubleshooting by allowing greater access to the individual components or subsystems and further enabling swift removal and replacement of the entire power module 100 if needed.

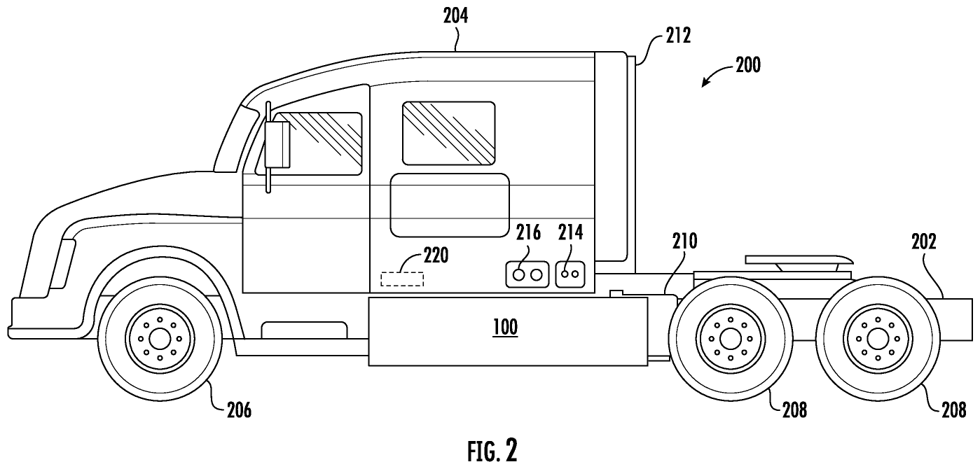

FIG. 2 shows a schematic side view of a vehicle 200 having one or more fully integrated compact power modules 100 according to an embodiment of the disclosure. In some embodiments, the vehicle 200 may include a truck or a truck/trailer combination and include a chassis 202 comprising a plurality of frame rails, a cab 204 supported by the chassis 202, a front wheeled axle 206, and one or more rear drive axles 208. In some embodiments, the vehicle 200 may include one or more motor/generators (M/G's) 210 coupled to one or more of the drive axles 208 of the vehicle 200 and configured to provide a motive force through the one or more drive axles 208 to propel the vehicle 200. In some embodiments, the vehicle 200 may include one or more fuel tanks 212 that store one or more fuels to supply to the power modules 100. In some embodiments, the vehicle 200 may also include one or more fuel connection ports 214 for receiving the one or more fuels into the one or more fuel tanks 212. In some embodiments, the vehicle 200 may include one or more electrical ports 216 to deliver the electrical power from the power modules 100 to at least one component or system independent of the vehicle 200. In some embodiments, the vehicle 200 may include an auxiliary power unit (APU), a heating, ventilation, and cooling (HVC) system, or a combination thereof.

The vehicle 200 may include a system controller 220, which may be an electronic control unit (ECU). In some embodiments, the system controller 220 may execute instructions to control operation of the power modules 100, the drivetrain of the vehicle 200, and/or the entire vehicle 200. In some embodiments, the system controller 220 may control operation of the vehicle 200, while each of the system controllers 110 control operation of its respective power modules 100. In some embodiments with multiple power modules 100, one of the system controllers 110 may operate as the master system controller to control operation of the power modules 100, the drivetrain of the vehicle 200, and/or the entire vehicle 200, while the system controllers 110 of the other power modules 100 may operate as slave system controllers. However, in other embodiments, only one power module 100 may include a system controller 110 that controls operation of the power modules 100, the drivetrain of the vehicle 200, and/or the entire vehicle 200.

The system controller 220 may execute instructions to control operation of the power modules 100, operation of the drivetrain of the vehicle 200, and/or operation of the entire vehicle 200. The system controller 220 and/or the system controllers 110 of the power modules 100 may execute instructions to selectively control power delivery of the electrical power from the battery system 104 and/or the generated electrical power from the generator 106 to internal or external systems or components. The system controller 220 and/or the system controllers 110 of the power modules 100 may execute instructions to selectively control power delivery based on: a destination; a location; a route; a grade of road; terrain; proximity of a fueling station to the destination, the location, and/or the route; a state of charge (SoC) of the battery system, or any combination thereof. The system controller 220 and/or the system controllers 110 of the power modules 100 may execute instructions to selectively control delivery of the heating or cooling to the at least one building, enclosure, or other structure. Further, the system controller 220 and/or the system controllers 110 of the power modules 100 may execute instructions to selectively control which of the one or more fuels are burned by the generator 106 of the power modules 100.

In operation, the one or more power modules 100 may supply the electrical power from the battery system 104 and/or the generated electrical power from the generator 106 to at least one component or system of the vehicle 200, at least one component or system independent of the vehicle 200 through the one or more electrical ports 216, or a combination thereof. In some embodiments, the at least one component of the vehicle 200 may include a drivetrain component of the vehicle 200, a non-drivetrain component of the vehicle 200, or a combination thereof. In some embodiments, the drivetrain component of the vehicle 200 may include the battery system 104 of the power modules 100, the generators 106 or the power modules 100, one or more motor/generators (M/G's) 210 coupled to one or more rear drive axles 208 of the vehicle 200, or a combination thereof. In some embodiments, the non-drivetrain component of the vehicle 200 may include an auxiliary power unit (APU) of the vehicle 200, a heating, ventilation, and cooling (HVC) system of the vehicle 200, or a combination thereof.

In some embodiments, the at least one component or system independent of the vehicle 200 may include an external electronic device, another electric or hybrid-electric vehicle, a building or other structure, the electrical grid, or a combination thereof. In some embodiments, the electrical ports 216 may be configured to receive a connection from an external electronic device, another electric or hybrid-electric vehicle, a building or other structure, the electrical grid, or a combination thereof to receive the electrical power from the power modules 100. Accordingly, in some embodiments, the electrical ports 216 may include a standard electrical outlet, an electric or hybrid-electric vehicle charging port, an A/C power outlet port, an electrical grid connection port, or a combination thereof.

The power modules 100 may also be configured to selectively supply heating or cooling to at least one building, enclosure, or other structure. In some embodiments, the power modules 100 may supply the electrical power from the battery systems 104 and/or the generated electrical power from the generators 106 to at least one component or system of the vehicle 200, at least one component or system independent of the vehicle 200, or a combination thereof and simultaneously supply heating to the at least one building, enclosure, or other structure. The heating from the power modules 100 may be generated by burning one or more fuels by the generators 106 of the power modules 100, and the generated heat may be supplied through the exhaust systems 134 of the generators 106 of the power modules 100. The cooling may be generated by powering the generators 106 with electrical power from the battery systems 104 without burning the one or more fuels, where the cooling may be supplied through the exhaust systems 134 of the generators 106 of the power modules 100.

The power modules 100 may be mounted to the chassis 202 of the vehicle 200. In some embodiments, the power modules 100 may be disposed outside the frame rails of the chassis 202 of the vehicle 200. In some embodiments, the power modules 100 may be disposed towards a rear of the cab 204 of the vehicle 200. Further, in some embodiments, the power modules 100 may be disposed on each of a left and right side of the vehicle 200.

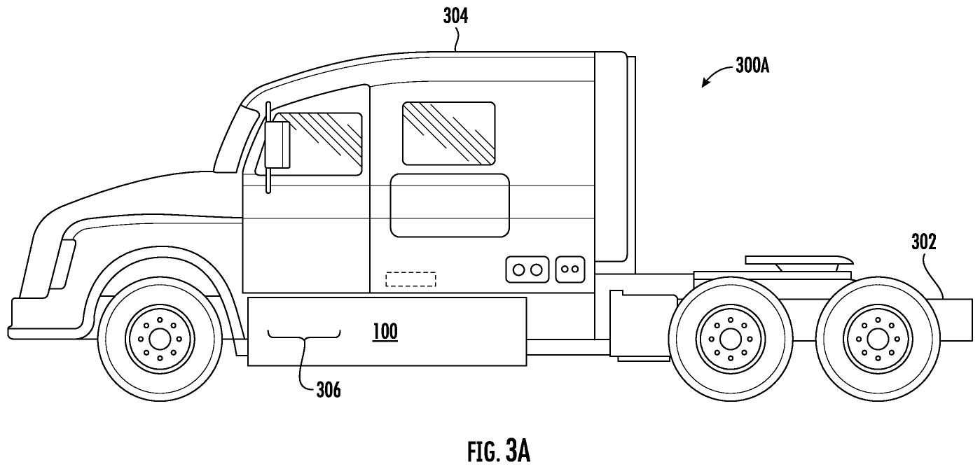

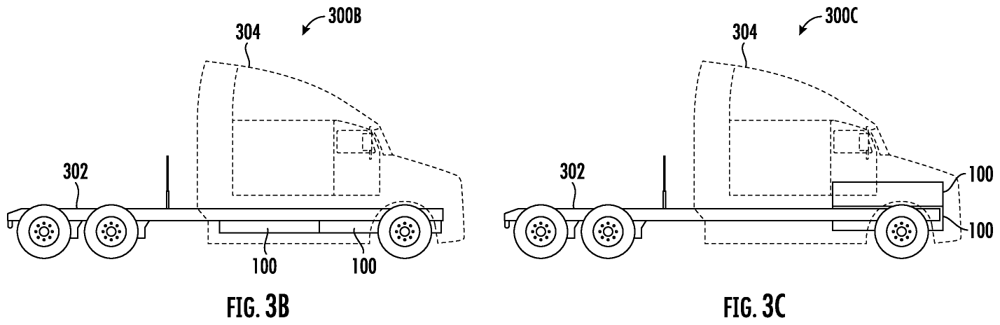

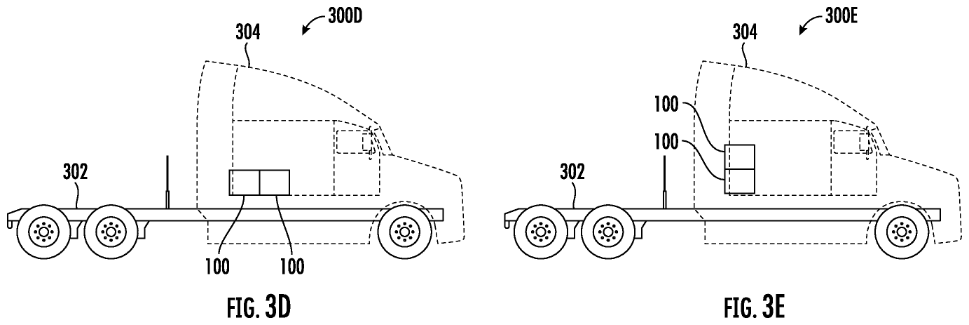

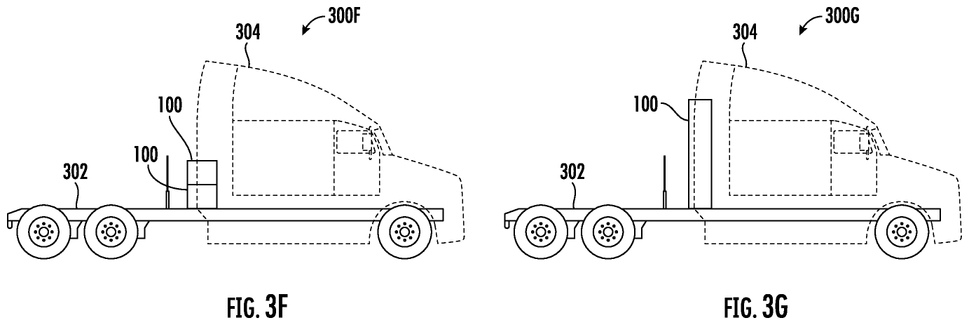

FIGS. 3A to 3G show schematic side views of vehicles 300A to 300G having a plurality of fully integrated compact power modules 100 according to embodiments of the disclosure. Vehicles 300A to 300G may be substantially similar to vehicle 200 and include one or more power modules 100 that may be operated in a substantially similar manner to the power modules 100 on vehicle 200. Vehicles 300A to 300G show the power modules 100 mounted in various locations on the vehicle. FIG. 3A shows vehicle 300A with the power modules 100 mounted to the chassis 302 of the vehicle 300A, disposed outside frame rails of the chassis 302 of the vehicle 300A, and towards a front of the cab 304 of the vehicle 300A. In some embodiments, the power modules 100 may include steps 306 formed in the housings 102 to aid a driver in entering and exiting the vehicle 300A. FIG. 3B shows vehicle 300B with the power modules 100 mounted to the chassis 302 of the vehicle 300B, disposed between the frame rails of the chassis 302, and disposed under the cab 304 of the vehicle 300B. In some embodiments, one power module 100 may be disposed forward of a second power module 100. FIG. 3C shows vehicle 300C with the power modules 100 mounted to the chassis of the vehicle 300C, disposed between the frame rails of the chassis 302, and under a center tunnel of the cab 304 of the vehicle 300C. In some embodiments, one power module 100 may be disposed on top of a second power module 100. FIG. 3D shows vehicle 300D with the power modules 100 disposed under a bed of a sleeper portion of the cab 304 of the vehicle 300D. In some embodiments, one power module 100 may be disposed forward of a second power module 100. FIG. 3E shows vehicle 300E with the power modules 100 disposed against a back wall of the sleeper portion of the cab 304 of the vehicle 300E. In some embodiments, one power module 100 may be disposed on top of a second power module 100. FIG. 3F shows vehicle 300F with the power modules 100 disposed horizontally across a back of the cab 304 of the vehicle 300F. In some embodiments, one power module 100 may be disposed on top of a second power module 100. FIG. 3G shows vehicle 300G with the power modules 100 disposed vertically across the back of the cab 304 of the vehicle 300G. While various embodiments of vehicles 300A to 300G are shown, it will be appreciated that the power modules 100 may be disposed in any combination of the above-referenced arrangements.

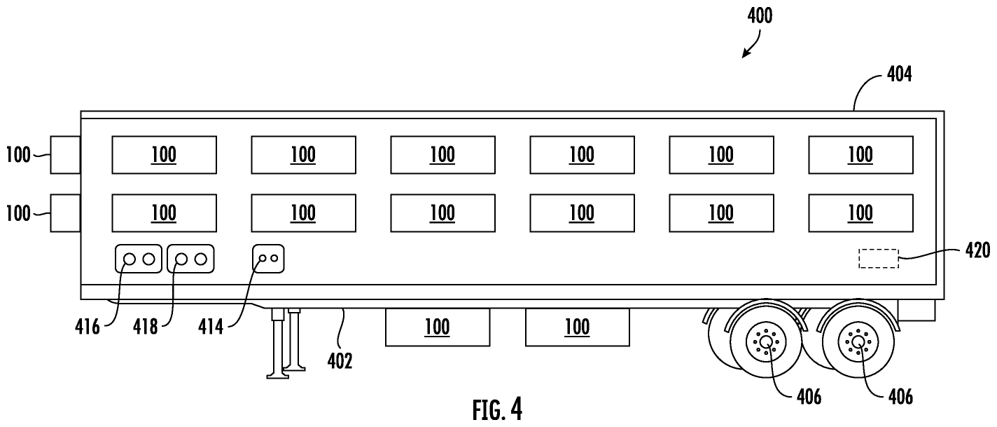

FIG. 4 shows a schematic side view of a vehicle 400 having a plurality of fully integrated compact power modules 100 according to an embodiment of the disclosure. In some embodiments, the vehicle 400 may include a trailer or an enclosed trailer and include a chassis 402 having a plurality of frame rails, an enclosure portion 404 supported by the chassis 402, and one or more wheeled axles 406. In some embodiments, the vehicle 400 may be towed by the vehicles 200, 300A, 300B, 300C, 300D, 300E, 300F, 300G. In some embodiments, the power modules 100 may be disposed between frame rails of the chassis 402, under the frame rails, under the enclosure portion 404, on a front of the enclosure portion 404, on a back of the enclosure portion 404, on sides of the enclosure portion 404, inside the enclosure portion 404, or a combination thereof.

In some embodiments, the vehicle 400 may include one or more fuel tanks (not shown) that store one or more fuels to supply to the power modules 100. In some embodiments, the vehicle 400 may also include one or more fuel connection ports 414 for receiving one or more fuels into one or more fuel tanks (not shown) on the vehicle 400. In some embodiments, the vehicle 400 may include one or more electrical ports 416 to deliver the electrical power from the power modules 100 to at least one component or system independent of the vehicle 400. In some embodiments, the vehicle 400 may include one or more heating or cooling ducts 418 coupled to an exhaust system 134 of each of the generators 106 of the power modules 100 through which the power modules 100 selectively supply heating or cooling to the at least one building, enclosure, or other structure. Further, in some embodiments, the vehicle 400 may also include a system controller 420 that controls the power modules 100 and/or the vehicle 400. However, in some embodiments, the system controller 220 of a tow vehicle, such as any of vehicles 200, 300A, 300B, 300C, 300D, 300E, 300F, 300G, may control the power modules 100.

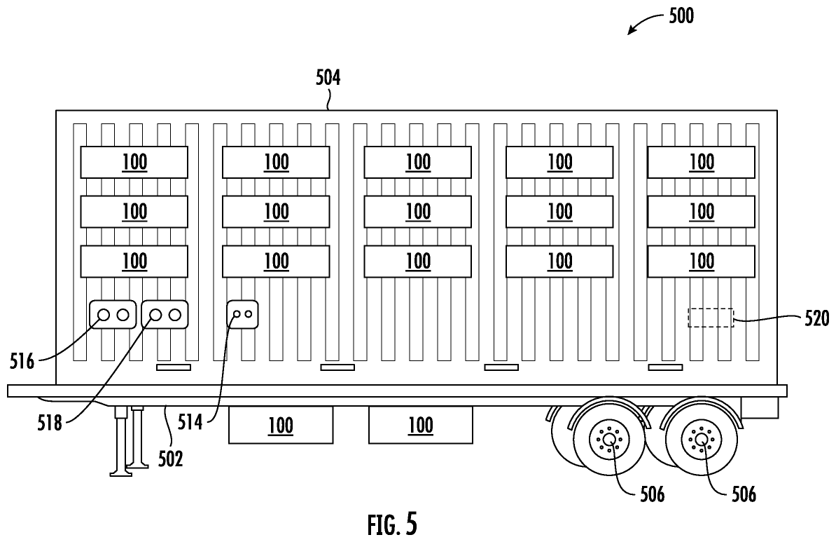

FIG. 5 shows a schematic side view of a vehicle 500 having a plurality of fully integrated compact power modules 100 according to an embodiment of the disclosure. In some embodiments, the vehicle 500 may include a trailered cargo container or any other trailered enclosure or structure and include a chassis 502 having a plurality of frame rails, an enclosure portion 504 supported by the chassis 502, and one or more wheeled axles 506. In some embodiments, the vehicle 500 may be towed by the vehicles 200, 300A, 300B, 300C, 300D, 300E, 300F, 300G. In some embodiments, the power modules 100 may be disposed between frame rails of the chassis 502, under the frame rails, under the enclosure portion 504, on a front of the enclosure portion 504, on a back of the enclosure portion 504, on sides of the enclosure portion 504, inside the enclosure portion 504, or a combination thereof.

In some embodiments, the vehicle 500 may include one or more fuel tanks (not shown) that store one or more fuels to supply to the power modules 100. In some embodiments, the vehicle 500 may also include one or more fuel connection ports 514 for receiving one or more fuels into one or more fuel tanks (not shown) on the vehicle 500. In some embodiments, the vehicle 500 may include one or more electrical ports 516 to deliver the electrical power from the power modules 100 to at least one component or system independent of the vehicle 500. In some embodiments, the vehicle 500 may include one or more heating or cooling ducts 518 coupled to an exhaust system 134 of each of the generators 106 of the power modules 100 through which the power modules 100 selectively supply heating or cooling to the at least one building, enclosure, or other structure. Further, in some embodiments, the vehicle 500 may also include a system controller 520 that controls the power modules 100 and/or the vehicle 500. However, in some embodiments, the system controller 220 of a tow vehicle, such as any of vehicles 200, 300A, 300B, 300C, 300D, 300E, 300F, 300G, may control the power modules 100.

Referring to FIGS. 4 and 5, the power modules 100 may be operated in a substantially similar manner to the power modules 100 on vehicle 200. The power modules 100 may supply the electrical power from the battery systems 104 and/or the generated electrical power from the generators 106 to at least one component or system of the vehicle 400, 500, at least one component or system independent of the vehicle 400, 500 through the one or more electrical ports 416, 516, or a combination thereof. In some embodiments, the at least one component or system independent of the vehicle 400, 500 may include an external electronic device, another electric or hybrid-electric vehicle, a building or other structure, the electrical grid, or a combination thereof. In some embodiments, the electrical ports 416, 516 may be configured to receive a connection from an external electronic device, another electric or hybrid-electric vehicle, a building or other structure, the electrical grid, or a combination thereof to receive the electrical power from the power modules 100. Accordingly, in some embodiments, the electrical ports 416, 516 may include a standard electrical outlet, an electric or hybrid-electric vehicle charging port, an A/C power outlet port, an electrical grid connection port, or a combination thereof.

The power modules 100 may also be configured to selectively supply heating or cooling to at least one building, enclosure, or other structure. In some embodiments, the power modules 100 may supply the electrical power from the battery systems 104 and/or the generated electrical power from the generators 106 to at least one component or system of the vehicle 400, 500, at least one component or system independent of the vehicle 400, 500, or a combination thereof and simultaneously supply heating to the at least one building, enclosure, or other structure. In some embodiments, the power modules 100 may supply heating or cooling to the at least one building, enclosure, or other structure through one or more heating or cooling ducts 418, 518 coupled to the exhaust system 134 of each of the generators 106 of the power modules 100. In some embodiments, the heating or cooling from each of the power modules 100 may be expelled directly into the enclosure 404, 504 from the exhaust system 134 of each of the generators 106 of the power modules 100 to provide a climate-controlled enclosure 404, 504. Providing and maintaining a climate-controlled enclosure 404, 504 may be performed during both over-the-roadway travel and while stationary.

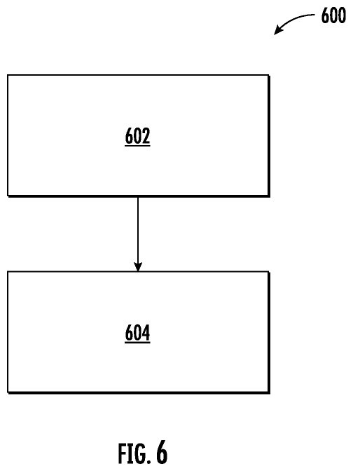

FIG. 6 shows a flowchart of a method 600 of operating a vehicle 200, 300A, 300B, 300C, 300D, 300E, 300F, 300G, 400, 500 according to an embodiment of the disclosure. The method 600 may begin at block 602 by providing a fully integrated compact power module 100 comprising: a housing 102; a battery system 104 disposed in the housing 102 and configured to selectively supply electrical power to at least one component or system; and a generator 106 disposed in the housing 102, coupled to the battery system 104, and configured to burn one or more fuels to generate electrical power to charge the battery system 104. The method 600 may continue at block 604 by one or more of: operating the generator 106 to burn one or more fuels to generate electrical power, heating, or a combination thereof; supplying the generated electrical power to the battery system 104, at least one component or system of the vehicle 200, 300A, 300B, 300C, 300D, 300E, 300F, 300G, 400, 500, at least one component or system independent of the vehicle 200, 300A, 300B, 300C, 300D, 300E, 300F, 300G, 400, 500 through the one or more electrical ports 122, or a combination thereof; supplying the electrical power from the battery system 104 to the generator 106, at least one component or system of the vehicle 200, 300A, 300B, 300C, 300D, 300E, 300F, 300G, 400, 500, at least one component or system independent of the vehicle 200, 300A, 300B, 300C, 300D, 300E, 300F, 300G, 400, 500 through the one or more electrical ports 122, or a combination thereof; and supplying cooling from the generator 106 to at least one building, enclosure, or other structure.

Further aspects are provided by the subject matter of the following clauses:

A fully integrated compact power module, comprising: a housing; a battery system disposed in the housing and configured to selectively supply electrical power to at least one component or system; and a generator disposed in the housing, coupled to the battery system, and configured to selectively burn one or more fuels to generate electrical power to charge the battery system.

The power module of any preceding clause, wherein the housing is configured for mounting to a vehicle, a structure, or a combination thereof.

The power module of any preceding clause, wherein the housing comprises one or more inlets that allow airflow into the housing.

The power module of any preceding clause, wherein the one or more inlets are oriented towards a primary direction of travel.

The power module of any preceding clause, wherein the one or more inlets operate as forced air induction inlets during travel.

The power module of any preceding clause, wherein the housing comprises one or more outlets that allow the airflow to escape from the housing.

The power module of any preceding clause, wherein the one or more outlets are disposed on a different side of the housing from the one or more inlets.

The power module of any preceding clause, wherein the housing comprises one or more exhaust outlets.

The power module of any preceding clause, wherein the housing comprises one or more electrical ports through which the battery system supplies the electrical power, the generator generates the electrical power, or a combination thereof to at least one component or system.

The power module of any preceding clause, wherein the battery system comprises one or more batteries or battery packs.

The power module of any preceding clause, wherein the one or more batteries or battery packs are disposed on one or more sides of the generator.

The power module of any preceding clause, wherein the one or more batteries or battery packs are disposed on a single side of the generator.

The power module of any preceding clause, wherein the one or more batteries or battery packs are disposed on a plurality of sides of the generator.

The power module of any preceding clause, wherein the battery system comprises a battery management controller configured to selectively control an amount of the electrical power supplied from the one or more batteries or battery packs.

The power module of any preceding clause, wherein the battery management controller is disposed in the housing.

The power module of any preceding clause, wherein the battery system comprises a battery cooling system to regulate a temperature of the one or more batteries or battery packs.

The power module of any preceding clause, wherein the battery cooling system comprises one or more battery cooling heat exchangers.

The power module of any preceding clause, wherein the one or more battery cooling heat exchangers are disposed externally to the housing.

The power module of any preceding clause, wherein the one or more battery cooling heat exchangers are disposed within the housing and proximate to one or more outlets in the housing.

The power module of any preceding clause, wherein the battery system is configured to supply the electrical power to at least one component or system of a vehicle, at least one component or system independent of the vehicle through the one or more electrical ports, or a combination thereof.

The power module of any preceding clause, wherein the at least one component of the vehicle is a drivetrain component of the vehicle.

The power module of any preceding clause, wherein the drivetrain component of the vehicle comprises the generator, one or more motor/generators (M/G's) coupled to one or more drive axles of the vehicle and configured to provide a motive force through the one or more drive axles to propel the vehicle, or a combination thereof.

The power module of any preceding clause, wherein the at least one component of the vehicle is a non-drivetrain component of the vehicle.

The power module of any preceding clause, wherein the non-drivetrain component of the vehicle comprises an auxiliary power unit (APU) of the vehicle, a heating, ventilation, and cooling (HVC) system of the vehicle, or a combination thereof.

The power module of any preceding clause, wherein the at least one component or system independent of the vehicle comprises an external electronic device, another electric or hybrid-electric vehicle, a building or other structure, the electrical grid, or a combination thereof.

The power module of any preceding clause, wherein the generator comprises a fuel agnostic generator.

The power module of any preceding clause, wherein the fuel agnostic generator is configured to burn compressed natural gas, diesel, hydrogen, liquified petroleum gas, or any combination thereof to generate electrical power to charge the battery system.

The power module of any preceding clause, wherein emissions from the generator comprise only carbon dioxide, nitrogen, water, or a combination thereof.

The power module of any preceding clause, wherein the generator is configured to expel the emissions through an exhaust system.

The power module of any preceding clause, wherein the exhaust system comprises one or more exhaust pipes that extend through the one or more exhaust outlets of the housing.

The power module of any preceding clause, wherein the generator is configured to supply the generated electrical power to at least one component or system of a vehicle, at least one component or system independent of the vehicle through the one or more electrical ports, or a combination thereof.

The power module of any preceding clause, wherein the at least one component of the vehicle is a drivetrain component of the vehicle.

The power module of any preceding clause, wherein the drivetrain component of the vehicle comprises the battery system, one or more motor/generators (M/G's) coupled to one or more drive axles of the vehicle and configured to provide a motive force through the one or more drive axles to propel the vehicle, or a combination thereof.

The power module of any preceding clause, wherein the at least one component of the vehicle is a non-drivetrain component of the vehicle.

The power module of any preceding clause, wherein the non-drivetrain component of the vehicle comprises an auxiliary power unit (APU) of the vehicle, a heating, ventilation, and cooling (HVC) system of the vehicle, or a combination thereof.

The power module of any preceding clause, wherein the at least one component or system independent of the vehicle comprises an external electronic device, another electric or hybrid-electric vehicle, a building or other structure, the electrical grid, or a combination thereof.

The power module of any preceding clause, wherein the generator is configured to selectively supply heating or cooling to at least one building, enclosure, or other structure.

The power module of any preceding clause, wherein the generator is configured to supply the generated electrical power to at least one component or system of a vehicle, at least one component or system independent of the vehicle, or a combination thereof and simultaneously supply heating to the at least one building, enclosure, or other structure.

The power module of any preceding clause, further comprising: a plurality of generators disposed in the housing, coupled to the battery system, and configured to burn one or more fuels to generate electrical power to charge the battery system.

The power module of any preceding clause, further comprising: a cooling system coupled to the generator and configured to regulate an operating temperature of the generator.

The power module of any preceding clause, wherein the cooling system comprises one or more heat exchangers configured to expel heat generated by the combustion of the one or more fuels by the generator.

The power module of any preceding clause, wherein the one or more heat exchangers are disposed externally to the housing.

The power module of any preceding clause, wherein the one or more heat exchangers are disposed within the housing and proximate to one or more outlets in the housing.

The power module of any preceding clause, further comprising: a system controller that executes instructions to control operation of the power module.

The power module of any preceding clause, wherein the system controller executes instructions to selectively control power delivery of the electrical power from the battery system and the generated electrical power from the generator to the at least one component or system of the vehicle, the at least one component or system independent of the vehicle, or a combination thereof.

The power module of any preceding clause, wherein the system controller executes instructions to selectively control power delivery based on: a destination; a location; a route; a grade of road; terrain; proximity of a fueling station to the destination, the location, and/or the route; a state of charge (SoC) of the battery system, or any combination thereof.

The power module of any preceding clause, wherein the system controller executes instructions to selectively control delivery of the heating or cooling to the at least one building, enclosure, or other structure.

The power module of any preceding clause, wherein the system controller executes instructions to selectively control which of the one or more fuels are burned by the generator.

The power module of any preceding clause, wherein the system controller is disposed in the housing.

The power module of any preceding clause, wherein the power module is capable of autonomous operation.

The power module of any preceding clause, wherein the power module is configured for mounting to and operation in a vehicle, a building, enclosure, or other structure, or a combination thereof.

The power module of any preceding clause, wherein the power module is operable in a vertical, horizontal, or angled position.

A vehicle, comprising: one or more fully integrated compact power modules, each power module comprising: a housing; a battery system disposed in the housing and configured to selectively supply electrical power to at least one component or system of the vehicle, at least one component or system independent of the vehicle, or a combination thereof; and a generator disposed in the housing, coupled to the battery system, and configured to selectively burn one or more fuels to generate electrical power to charge the battery system.

The vehicle of any preceding clause, wherein the housing is configured for mounting to the vehicle.

The vehicle of any preceding clause, wherein the housing comprises one or more inlets that allow airflow into the housing.

The vehicle of any preceding clause, wherein the one or more inlets are oriented towards a primary direction of travel of the vehicle.

The vehicle of any preceding clause, wherein the one or more inlets operate as forced air induction inlets during travel of the vehicle.

The vehicle of any preceding clause, wherein the housing comprises one or more outlets that allow the airflow to escape from the housing.

The vehicle of any preceding clause, wherein the one or more outlets are disposed on a different side of the housing from the one or more inlets.

The vehicle of any preceding clause, wherein the housing comprises one or more exhaust outlets.

The vehicle of any preceding clause, wherein the battery system comprises one or more batteries or battery packs.

The vehicle of any preceding clause, wherein the one or more batteries or battery packs are disposed on one or more sides of the generator.

The vehicle of any preceding clause, wherein the one or more batteries or battery packs are disposed on a single side of the generator.

The vehicle of any preceding clause wherein the one or more batteries or battery packs are disposed on a plurality of sides of the generator.

The vehicle of any preceding clause, wherein the battery system comprises a battery management controller configured to selectively control an amount of the electrical power supplied from the one or more batteries or battery packs.

The vehicle of any preceding clause, wherein the battery management controller is disposed in the housing.

The vehicle of any preceding clause, wherein the battery system comprises a battery cooling system to regulate a temperature of the one or more batteries or battery packs.

The vehicle of any preceding clause, wherein the battery cooling system comprises one or more battery cooling heat exchangers.

The vehicle of any preceding clause, wherein the one or more battery cooling heat exchangers are disposed externally to the housing and on the vehicle.

The vehicle of any preceding clause, wherein the one or more battery cooling heat exchangers are disposed within the housing and proximate to one or more outlets in the housing.

The vehicle of any preceding clause, wherein the battery system is configured to supply the electrical power to at least one component or system of the vehicle, at least one component or system independent of the vehicle through the one or more electrical ports, or a combination thereof.

The vehicle of any preceding clause, wherein the at least one component of the vehicle is a drivetrain component of the vehicle.

The vehicle of any preceding clause, wherein the drivetrain component of the vehicle comprises the generator, one or more motor/generators (M/G's) coupled to one or more drive axles of the vehicle and configured to provide a motive force through the one or more drive axles to propel the vehicle, or a combination thereof.

The vehicle of any preceding clause, wherein the at least one component of the vehicle is a non-drivetrain component of the vehicle.

The vehicle of any preceding clause, wherein the non-drivetrain component of the vehicle comprises an auxiliary power unit (APU) of the vehicle, a heating, ventilation, and cooling (HVC) system of the vehicle, or a combination thereof.

The vehicle of any preceding clause, wherein the at least one component or system independent of the vehicle comprises an external electronic device, another electric or hybrid-electric vehicle, a building or other structure, the electrical grid, or a combination thereof.

The vehicle of any preceding clause, wherein the generator comprises a fuel agnostic generator.

The vehicle of any preceding clause, wherein the fuel agnostic generator is configured to burn compressed natural gas, diesel, hydrogen, liquified petroleum gas, or any combination thereof to generate electrical power to charge the battery system.

The vehicle of any preceding clause, wherein emissions from the generator comprise only carbon dioxide, nitrogen, water, or a combination thereof.

The vehicle of any preceding clause, wherein the generator is configured to expel the emissions through an exhaust system.

The vehicle of any preceding clause, wherein the exhaust system comprises one or more exhaust pipes that extend through the one or more exhaust outlets of the housing.

The vehicle of any preceding clause, wherein the generator is configured to supply the generated electrical power to at least one component or system of the vehicle, at least one component or system independent of the vehicle through the one or more electrical ports, or a combination thereof.

The vehicle of any preceding clause, wherein the at least one component of the vehicle is a drivetrain component of the vehicle.

The vehicle of any preceding clause, wherein the drivetrain component of the vehicle comprises the battery system, one or more motor/generators (M/G's) coupled to one or more drive axles of the vehicle and configured to provide a motive force through the one or more drive axles to propel the vehicle, or a combination thereof.

The vehicle of any preceding clause, wherein the at least one component of the vehicle is a non-drivetrain component of the vehicle.

The vehicle of any preceding clause, wherein the non-drivetrain component of the vehicle comprises an auxiliary power unit (APU) of the vehicle, a heating, ventilation, and cooling (HVC) system of the vehicle, or a combination thereof.

The vehicle of any preceding clause, wherein the at least one component or system independent of the vehicle comprises an external electronic device, another electric or hybrid-electric vehicle, a building or other structure, the electrical grid, or a combination thereof.

The vehicle of any preceding clause, wherein the generator is configured to selectively supply heating or cooling to at least one building, enclosure, or other structure.

The vehicle of any preceding clause, wherein the generator is configured to supply the generated electrical power to at least one component or system of the vehicle, at least one component or system independent of the vehicle, or a combination thereof and simultaneously supply heating to the at least one building, enclosure, or other structure.

The vehicle of any preceding clause, further comprising: a plurality of generators disposed in the housing, coupled to the battery system, and configured to burn one or more fuels to generate electrical power to charge the battery system.

The vehicle of any preceding clause, further comprising: a cooling system coupled to the generator and configured to regulate an operating temperature of the generator.

The vehicle of any preceding clause, wherein the cooling system comprises one or more heat exchangers configured to expel heat generated by the combustion of the one or more fuels by the generator.

The vehicle of any preceding clause, wherein the one or more heat exchangers are disposed externally to the housing.

The vehicle of any preceding clause, wherein the one or more heat exchangers are disposed within the housing and proximate to one or more outlets in the housing.

The vehicle of any preceding clause, further comprising: a system controller that executes instructions to control operation of the power module.

The vehicle of any preceding clause, wherein the system controller executes instructions to selectively control power delivery of the electrical power from the battery system and the generated electrical power from the generator to the at least one component or system of the vehicle, the at least one component or system independent of the vehicle, or a combination thereof.

The vehicle of any preceding clause, wherein the system controller executes instructions to selectively control power delivery based on: a destination; a location; a route; a grade of road; terrain; proximity of a fueling station to the destination, the location, and/or the route; a state of charge (SoC) of the battery system, or any combination thereof.

The vehicle of any preceding clause, wherein the system controller executes instructions to selectively control delivery of the heating or cooling to the at least one building, enclosure, or other structure.

The vehicle of any preceding clause, wherein the system controller executes instructions to selectively control which of the one or more fuels are burned by the generator.

The vehicle of any preceding clause, wherein the system controller executes instructions to control operation of the drivetrain of the vehicle.

The vehicle of any preceding clause, wherein the system controller further executes instructions to control operation of the vehicle.

The vehicle of any preceding clause, wherein the system controller is disposed in the housing.

The vehicle of any preceding clause, wherein the vehicle comprises one or more electrical ports to deliver the electrical power from the battery system, the generated electrical power from the generator, or a combination thereof to the at least one component or system independent of the vehicle.

The vehicle of any preceding clause, wherein the electrical ports are configured to receive a connection from an external electronic device, another electric or hybrid-electric vehicle, a building or other structure, the electrical grid, or a combination thereof to receive the electrical power from the battery system, the generated electrical power from the generator, or a combination thereof.

The vehicle of any preceding clause, wherein the electrical ports comprise a standard electrical outlet, an electric or hybrid-electric vehicle charging port, an A/C power outlet port, an electrical grid connection port, or a combination thereof.

The vehicle of any preceding clause, wherein the vehicle comprises one or more heating or cooling ports or ducts coupled to an exhaust system of each of the one or more generators to selectively supply heating or cooling to the at least one building, enclosure, or other structure.

The vehicle of any preceding clause, wherein the heating or cooling from each of the one or more power modules is expelled directly into the enclosure from the exhaust system of each of the one or more generators.

The vehicle of any preceding clause, wherein the enclosure comprises an enclosed trailer, a cargo container, or other enclosure in which the one or more power modules are mounted.

The vehicle of any preceding clause wherein the heating is generated by the burning of the one or more fuels by the generator, and wherein the heating is supplied through the exhaust system of the generator.

The vehicle of any preceding clause, wherein the cooling is generated by the powering of the generator by the battery system without burning the one or more fuels, and wherein the cooling is supplied through the exhaust system of the generator.

The vehicle of any preceding clause, wherein the vehicle comprises one or more fuel tanks that store the one or more fuels to supply the one or more fuels to the generator.

The vehicle of any preceding clause, wherein the vehicle comprises one or more fuel connection ports for receiving the one or more fuels into the one or more fuel tanks.

The vehicle of any preceding clause, wherein the power module is configured for mounting to the vehicle, and wherein the power module is operable in a vertical, horizontal, or angled position.

The vehicle of any preceding clause, wherein the vehicle comprises a truck comprising a plurality of power modules.

The vehicle of any preceding clause, wherein the power modules are mounted to a chassis of the truck.

The vehicle of any preceding clause, wherein the power modules are disposed outside frame rails of the chassis, between the frame rails of the chassis, between the frame rails of the chassis and under a center tunnel of a cab of the truck, under a bed of a sleeper portion of the cab, against a back wall of the sleeper portion of the cab, horizontally across a back of the cab, vertically across the back of the cab, or a combination thereof.

The vehicle of any preceding clause, where the vehicle comprises a trailer, an enclosed trailer, or a trailered cargo container comprising a plurality of power modules.

The vehicle of any preceding clause, wherein the power modules are mounted to a chassis of the trailer, the enclosure portion of the trailer, or a combination thereof.

The vehicle of any preceding clause, wherein the power modules are disposed between frame rails of the chassis, under the frame rails, under the enclosure portion, on a front of the enclosure portion, on a back of the enclosure portion, on sides of the enclosure portion, inside the enclosure portion, or a combination thereof.

A method of operating a vehicle comprising one or more fully integrated compact power modules, comprising: providing a fully integrated compact power module comprising: a housing; a battery system disposed in the housing and configured to selectively supply electrical power to at least one component or system; and a generator disposed in the housing, coupled to the battery system, and configured to burn one or more fuels to generate electrical power to charge the battery system; and one or more of: operating the generator to burn one or more fuels to generate electrical power, heating, or a combination thereof; supplying the generated electrical power to the battery system, at least one component or system of the vehicle, at least one component or system independent of the vehicle through one or more electrical port, or a combination thereof; supplying the electrical power from the battery system to the generator, at least one component or system of the vehicle, at least one component or system independent of the vehicle through the one or more electrical ports, or a combination thereof; and supplying cooling from the generator to at least one building, enclosure, or other structure.

Note that not all of the activities or features described above in the detailed description or in the examples are required, that a portion of a specific activity or feature may not be required, and that one or more further activities or features may be performed in addition to those described. Still further, the order in which activities are listed is not necessarily the order in which they are performed.

In the foregoing specification, the concepts have been described with reference to specific embodiments. However, those of ordinary skill in the art appreciate that various modifications and changes can be made without departing from the scope of the invention as set forth in the claims below. Accordingly, the specification and figures are to be regarded in an illustrative rather than in a restrictive sense, and all such modifications are intended to be included within the scope of the invention.

As used herein, the terms “comprises,” “comprising,” “includes,” “including,” “has,” “having,” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present), and B is false (or not present), A is false (or not present), and B is true (or present), and both A and B are true (or present).

Also, the use of “a” or “an” is employed to describe elements and components described herein. This is done merely for convenience and to give a general sense of the scope of the invention. This description should be read to include one or at least one, and the singular also includes the plural unless it is obvious that it is meant otherwise.

Benefits, other advantages, and solutions to problems have been described above with respect to one or more specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, those of ordinary skill in the art will appreciate that certain features that are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A fully integrated compact power module, comprising:
a housing;
a battery system disposed in the housing and configured to selectively supply electrical power to at least one component or system, the battery system comprising one or more batteries or battery packs; and
a fuel agnostic generator disposed in the housing, the fuel agnostic generator coupled to the battery system and being adjacent to the one or more batteries or battery packs, the fuel agnostic generator further configured to selectively burn one or more fuels to generate electrical power to charge the battery system.

2. The fully integrated compact power module of claim 1, wherein the housing is configured for mounting to a vehicle, a structure, or a combination thereof.

3. The fully integrated compact power module of claim 1, wherein the housing comprises one or more inlets that allow airflow into the housing, one or more outlets that allow the airflow to escape from the housing, and one or more exhaust outlets, wherein the one or more inlets are oriented towards a primary direction of travel, and wherein the one or more outlets are disposed on a different side of the housing from the one or more inlets.

4. The fully integrated compact power module of claim 1, wherein the housing comprises one or more electrical ports through which the battery system supplies the electrical power, the fuel agnostic generator supplies the generated electrical power, or a combination thereof to at least one component or system.

5. The fully integrated compact power module of claim 1, wherein the battery system comprises a battery management controller configured to selectively control an amount of the electrical power supplied from the one or more batteries or battery packs, the battery management controller being disposed in the housing.

6. The fully integrated compact power module of claim 1, wherein the battery system comprises a battery cooling system to regulate a temperature of the one or more batteries or battery packs.

7. The fully integrated compact power module of claim 6, wherein the battery cooling system comprises one or more battery cooling heat exchangers.

8. The fully integrated compact power module of claim 1, wherein the battery system is configured to supply the electrical power to at least one component or system of a vehicle, at least one component or system independent of the vehicle through the one or more electrical ports, or a combination thereof.

9. The fully integrated compact power module of claim 1, further comprising: a plurality of fuel agnostic generators disposed in the housing, coupled to the battery system, and configured to burn one or more fuels to generate electrical power to charge the battery system.

10. The fully integrated compact power module of claim 1, further comprising: a cooling system coupled to the fuel agnostic generator and configured to regulate an operating temperature of the fuel agnostic generator.

11. The fully integrated compact power module of claim 10, wherein the cooling system comprises one or more heat exchangers configured to expel heat generated by the combustion of the one or more fuels by the fuel agnostic generator.

12. The fully integrated compact power module of claim 1, further comprising: a system controller that executes instructions to control operation of the fully integrated compact power module.

13. A vehicle, comprising:
one or more fully integrated compact power modules, each fully integrated compact power module comprising:
a housing;
a battery system disposed in the housing and configured to selectively supply electrical power to at least one component or system of the vehicle, at least one component or system independent of the vehicle, or a combination thereof, the battery system comprising one or more batteries or battery packs; and
a fuel agnostic generator disposed in the housing, coupled to the battery system, and configured to selectively burn one or more fuels to generate electrical power to charge the battery system.

14. The vehicle of claim 13, wherein the housing is configured for mounting to the vehicle.

15. The vehicle of claim 13, wherein the housing comprises one or more inlets that allow airflow into the housing, one or more outlets that allow the airflow to escape from the housing, and one or more exhaust outlets, wherein the one or more inlets are oriented towards a primary direction of travel, and wherein the one or more outlets are disposed on a different side of the housing from the one or more inlets.

16. The vehicle of claim 13, wherein the housing comprises one or more exhaust outlets.

17. The vehicle of claim 13, wherein the battery system comprises a battery management controller configured to selectively control an amount of the electrical power supplied from the one or more batteries or battery packs.

18. The vehicle of claim 13, wherein the battery system comprises a battery cooling system to regulate a temperature of the one or more batteries or battery packs, wherein the battery cooling system comprises one or more battery cooling heat exchangers.

19. The vehicle of claim 13, further comprising: a plurality of generators disposed in the housing, coupled to the battery system, and configured to burn one or more fuels to generate electrical power to charge the battery system.

20. The vehicle of claim 13, further comprising: a cooling system coupled to the generator and configured to regulate an operating temperature of the generator, wherein the cooling system comprises one or more heat exchangers configured to expel heat generated by the combustion of the one or more fuels by the generator.
